(19) United States
(12) Patent Application Publication
(10) Pub. No.: US 2017/0229803 A1
(43) Pub. Date: Aug. 10, 2017

(54) METHODS AND DEVICES THAT FACILITATE OBJECT ORIENTATION

(71) Applicant: David L. Putnam, Sammamish, WA (US)

(72) Inventor: David L. Putnam, Sammamish, WA (US)

(21) Appl. No.: 15/428,042

(22) Filed: Feb. 8, 2017

Related U.S. Application Data
(60) Provisional application No. 62/292,777, filed on Feb. 8, 2016.

(51) Int. Cl. H01R 13/46; E05B 19/00; E05B 19/04; H01R 24/64

(52) U.S. Cl. CPC H01R 13/465; H01R 24/64; E05B 19/0094; E05B 19/04; H01R 2107/00

(57) ABSTRACT

The current document is directed to methods and devices that facilitate object orientation. In particular, the current document is directed to methods and devices that facilitate tactile orientation of objects, such as connectors, keys, cards, and other objects that are manipulated by human users for insertion into complementary connectors, slots, and other receptacles. In addition to facilitating tactile orientation of objects, the devices and additionally provide mechanical advantage for objects insertion and removal and may additionally provide visual orientation indications, and other indications, to human users. The currently disclosed devices are tangible, physical objects or features that, when held, felt, and/or manipulated by human users, provide a tactile indication of the orientation of an engagement feature of an object is inserted into a complementary connector, slot, port, or other receptacle.

### CROSS-REFERENCE TO RELATED APPLICATION

This application claims the benefit of Provisional Application No. 62/292,777, filed Feb. 8, 2016.

### TECHNICAL FIELD

The current document is directed to the object-orientation methods and devices and, in particular, to devices and methods that employ the devices to facilitate manual orientation of various types of connectors, keys, and other such objects that are pushed or inserted into complementary connectors, slots, and other receptacles.

### BACKGROUND

Many different types of connectors, keys, plugs, cards, and other objects are commonly used in the modern world. For example, many different types of power and data-transmission cables terminate in a connector or adapter that is complementary to a connector or port on a power supply, power source, and/or data source. When a computer user, for example, wishes to connect the computer to a power source, the computer user pushes the connector at the end of a power cable already connected to the power source into a complementary connector or port on the surface of the computer. Similarly, when the computer user wishes to connect the computer to a peripheral electronic device, the computer user plugs the connectors at each end of a data-transmission cable into complementary connectors or ports of the computer and peripheral device. There are many different types of electrical connectors, including the universal serial bus (“USB”), FireWire, i.Link, high-definition multimedia interface (“HDMI”), and a variety of different multi-pin connectors used to connect display terminals, keyboards, and other peripheral devices to desktop computers. In certain cases, a connector, such as a USB connector, can be used both for connecting a computer or cell phone to a power supply as well as for connecting the computer or cell phone to a data source. Various types of ATM cards and smartcards are inserted into card slots to authorize financial transactions by exchanging data with centralized computer systems within financial institutions. Keys are commonly used to unlock house doors, bicycle locks, and other types of locks as well as to operate the ignition system of automobiles and other vehicles. These are a few examples of the many different types of objects that are manipulated by human beings to engage with complementary connectors, ports, slots, or other receptacles for many different purposes.

In many cases, the objects that are manipulated by human beings to engage with complementary connectors and receptacles include engagement features with less symmetry than the object handle. For example, a USB connector has a bilaterally symmetric cross-section, but because the top surface is wider than the lower bottom surface, the USB connector lacks a proper rotation axis parallel to the direction of insertion and removal from a complementary port. As a result, the USB connector must be properly rotationally oriented with the top wider surface matching a wider opening of the port in order to successfully insert the USB connector into a complementary USB port. Similarly, a key blank often includes a shaft with two orthogonal mirror-plane symmetry parallel to the central, long central axis of the shaft. However, when the key blank is cut to create the irregular pattern of teeth along one edge of the shaft, at least one of the mirror-plane symmetry elements is lost, and the resulting key is less symmetrical than the key blank. Many ATM cards and smartcards of a magnetic stripe on only one of the two surfaces parallel to one set of edges. In many cases, the ATM card or smartcard must be correctly oriented for the magnetic stripe to align with a card reader into which the ATM card or smartcard is inserted in order to authorize a transaction. This is also the case for credit cards used in gas pumps and grocery-store credit-card readers. However, in all of the above-mentioned cases, the handle or surfaces of the object grasped by a human user commonly has greater symmetry than the engagement feature that needs to be inserted into a complementary device or receptacle. For example, a USB connector often emerges from a roughly rectangular plastic plug. In many cases, the rectangular plastic plug has a 2-fold or 4-fold symmetry axis parallel to the cable, on one side, and the long axis of the USB, on the other side. To a human user, the rectangular plastic plug has the same apparent shape and orientation when rotated about a 2-fold symmetry axis by 180°. However, the USB connector, or engagement feature, does not have a 2-fold or 4-fold symmetry axis parallel to that of the rectangular plastic plug, and therefore has a different shape and orientation when rotated about an axis parallel to the long symmetry axis of rectangular plastic plug by 180°. Often, particularly for older people, it is difficult to visually ascertain the orientation of the USB connector and, as a result, users often repeatedly attempt to insert a USB connector with an incorrect orientation into a USB port. This can result in time-consuming fumbling, annoyance, and even damage to the USB connector, USB port, or both. Similarly, when an ATM user is rushed or when the ATM machine is poorly lighted, the ATM user may inadvertently insert the ATM card into the ATM-card reader in one of several different incorrect orientations, again resulting in time-consuming fumbling and multiple attempts, annoyance, and possibly increased wear and damage to the ATM card, in particular to the magnetic stripe on the surface of the ATM card. There are probably few, if any, people who have never experienced the annoyance of incorrectly inserting keys into the key slots of house doors or vehicle-ignition subsystems. In both the case of the ATM card and keys, the object surface grasped by the user has greater apparent symmetry than that the engagement feature that needs to be properly oriented before insertion into the complementary receptacle. A user cannot tell, by feel alone, whether or not the engagement feature of the object is properly oriented, because there are one or more alternative positions in which the orientation of the handle or grasped surface feels the same, but in which the engagement feature is improperly oriented. In many cases, even when the object is in full view, a user may nonetheless fail to properly oriented the engagement feature of the object for insertion into the complementary receptacle do to the small size of the engagement feature or lack of clear orientation indications on the slot, connector, port, or other receptacle into which the engagement feature needs to be inserted.

While a seemingly relatively insignificant problem, the frequent inability of human users to properly orient connectors, keys, cards, and other such devices prior to insertion into a complementary connector, slot, or other receptacle, represents a significant inefficiency in human/machine interaction as well as a significant source of wear and damage to the mechanical, electromechanical, and electro-optical-mechanical systems accessed by connectors, keys, cards, and other such devices.

### SUMMARY

The current document is directed to methods and devices that facilitate object orientation. In particular, the current document is directed to methods and devices that facilitate tactile orientation of objects, such as connectors, keys, cards, and other objects that are manipulated by human users for insertion into complementary connectors, slots, and other receptacles. In addition to facilitating tactile orientation of objects, the devices and additionally provide mechanical advantage for objects insertion and removal and may additionally provide visual orientation indications, and other indications, to human users. The currently disclosed devices are tangible, physical objects or features that, when held, felt, and/or manipulated by human users, provide a tactile indication of the orientation of an engagement feature of an object is inserted into a complementary connector, slot, port, or other receptacle.

### BRIEF DESCRIPTION OF THE DRAWINGS

FIG. 1 illustrates a first implementation of the currently disclosed tactile orientation devices.

FIGS. 1A-D illustrates symmetry elements of components of the USB cable, discussed above with reference to FIG. 1, with and without the tactile orientation device.

FIG. 2 illustrates a second implementation of the tactile orientation devices disclosed in the current document.

FIG. 3 illustrates a third implementation of the tactile orientation devices disclosed in the current document.

FIG. 4 illustrates a fourth implementation of the tactile orientation devices disclosed in the current document.

FIG. 5 illustrates a fifth implementation of the tactile orientation devices disclosed in the current document.

FIG. 6 illustrates a sixth implementation of the tactile orientation devices disclosed in the current document.

FIG. 7 illustrates a seventh implementation of the tactile orientation devices disclosed in the current document.

### DETAILED DESCRIPTION

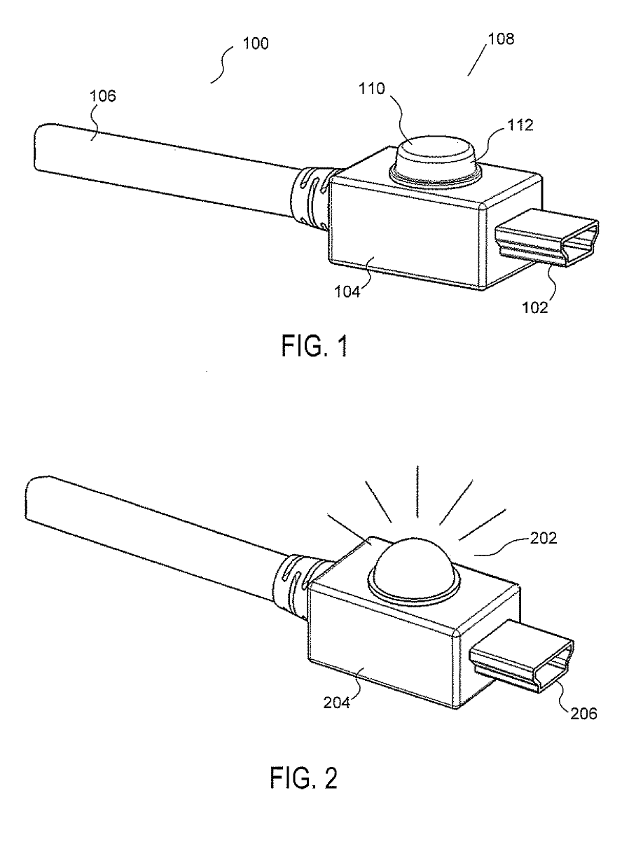

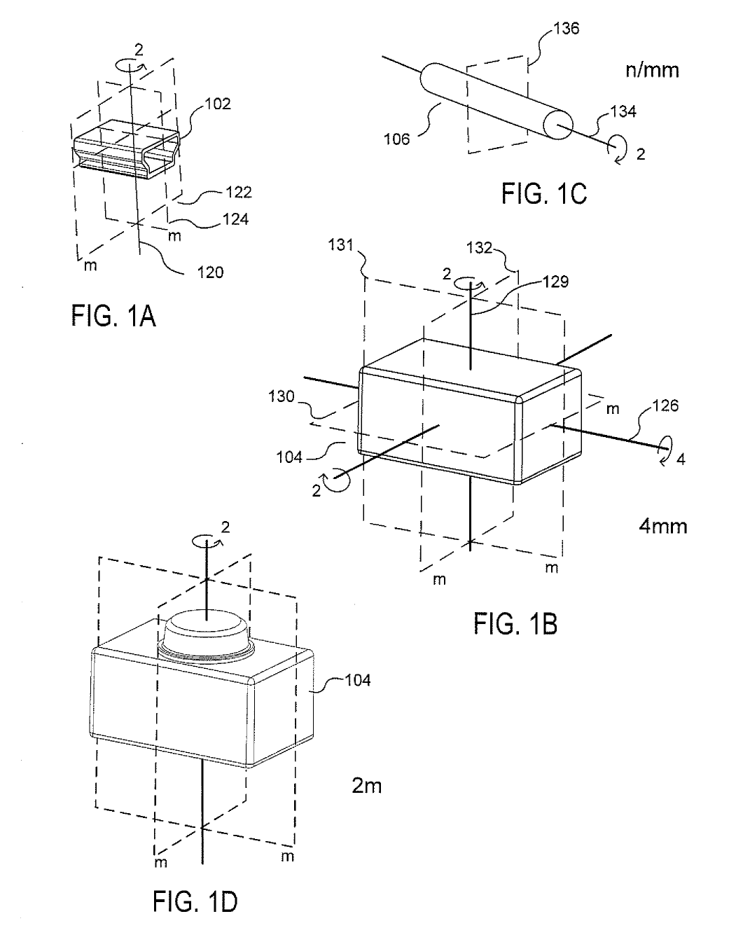

FIG. 1 illustrates a first implementation of the currently disclosed tactile orientation devices. FIG. 1 shows a portion of a USB cable 100 that includes a USB connector 102, a rectangular connector body 104 from which the USB connector extends, and an electric cable 106 that includes wires and/or other conductive elements at interconnect through the rectangular connector body to the USB connector. As shown in FIG. 1, a tactile orientation device 108 has been included on the top surface of the rectangular connector body. The tactile orientation device is a cylindrical-section or conical-section shape with a planar or slightly curved top disk-shaped surface 110 and a side wall 112. The tactile orientation device may be molded together with the rectangular connector body, separately manufactured and permanently affixed to the rectangular connector body, or, in certain implementations, may be semi-permanently affixed to the retailer connector body, allowing the tactile orientation device to be repositioned or removed. FIGS. 1A-D illustrates symmetry elements of components of the USB cable, discussed above with reference to FIG. 1, with and without the tactile orientation device. As discussed above, in the background section, the rectangular connector body 104 of the USB cable, without the tactile orientation device, has greater symmetry than the USB connector 102. The cable has even greater symmetry than both the rectangular connector body and the USB connector. The symmetry elements for these three components are shown in FIGS. 1A-C. The USBE connector 102 has 2m symmetry, as shown in FIG. 1A, with a vertical 2-fold symmetry axis 120 and two vertical mirror planes 122 and 124. There is no proper symmetry rotation axis perpendicular to the 2-fold axis 120 and thus no proper rotation axis parallel to the direction in which the USB connector is inserted or removed from a complementary USB port. By contrast, the rectangular connector body 104 without the tactile orientation device 110, as shown in FIG. 1B, has a 4-fold symmetry axis 126 parallel to the central axes of the cable 106, rectangular connector body 104, and USB connector 102, which defines the direction in which the USB connector is inserted or removed from a complementary USB port. This, of course, assumes that the width and height of the rectangular connector body are identical. The rectangular connector body therefore would feel the same, and have the same visual appearance, when rotated by 900, 180°, and 270° about the 4-fold symmetry axis. Therefore, there are three orientations of the rectangular connector body without the tactile orientation device equivalent to the orientation shown in FIG. 1 in which the USB connector is improperly oriented with respect to a complementary port. The rectangular connector body without the tactile orientation device has 4 mm symmetry and has two additional 2-fold symmetry axes 128-129 and three mirror planes 130-132. The electric cable 106, as shown in FIG. 1C, has an infinite-fold symmetry axis 134 corresponding to the central, long axis of the cable when the cable is not bent or curved, as well as an infinite number of mirror planes parallel to, and coincident with, the n-fold axis, not shown in FIG. 1C, and a perpendicular mirror plane 136. The cable has n/mm symmetry. A user holding the cable and rectangular connector body cannot tell, by feel, whether the USB connector is in the orientation shown in FIG. 1 or in an orientation obtained by a 900, 180°, or 270° rotation about the 4-fold symmetry axis 126. This is a result of the rectangular connector body and cable having greater symmetry than the USB connector.

The presence of the tactile orientation device removes the 4-fold symmetry axis of the rectangular connector body, as shown in FIG. 1D. The rectangular connector body with the tactile orientation device has 2m symmetry—the same symmetry as the USB connector. By reducing the symmetry of the rectangular connector body, the tactile orientation device allows a human user to determine the orientation of both the rectangular connector body and the USB connector by feel. When the tactile orientation device is vertically oriented, the USB connector has the orientation shown in FIG. 1. By feel alone, a human user can properly orient the USB connector for insertion into a complementary connector or port. In addition, the tactile orientation device 108 provides a rigid surface roughly perpendicular to the direction of USB-connector insertion to provide a mechanical advantage to a user when inserting or removing the USB connector from a complementary connector or port.

FIG. 2 illustrates a second implementation of the tactile orientation devices disclosed in the current document. The tactile orientation device 202 in this implementation has a spherical surface, different in shape and feel from the tactile orientation device 108 shown in FIG. 1. Tactile orientation device 202 may include a light source to provide an additional, visual indication of the orientation of the rectangular connector body 204 and USB connector 206. The light source may be included within the tactile orientation device or within the rectangular connector body. The light source may be a light-emitting diode (“LED”) that is powered from the same power source that powers the USB connector. Alternatively, the light may be emitted by fluorophores or phosphorescent materials incorporated within the tactile orientation device. In additional implementations, the tactile orientation device has a reflective surface or colored to provide additional visual cues to human users. In the case of an LED light source, the light may not only provide a visual indication of the orientation of the rectangular connector body and USB connector, but may also facilitate aligning the USB connector with the complementary USB port in low-illumination environments.

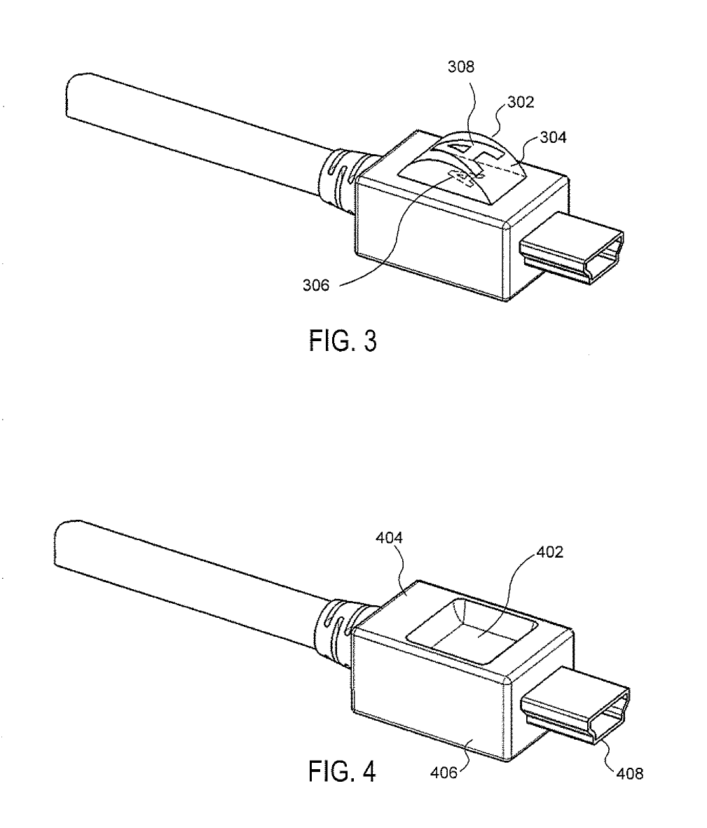

FIG. 3 illustrates a third implementation of the tactile orientation devices disclosed in the current document. In this implementation, the tactile orientation device 302 has a cylindrical surface 304. The surface is transparent and magnifies a printed mark or label 306 below the cylindrical surface to produce and easily read image 308 of the label or marking coincident with the spherical surface. Thus, various implementations of the tactile orientation devices disclosed in the current document can include markings, labels, numbers, or other visual indicators to facilitate identification of the type of connector, matching the connector to a complementary port, also labeled with the indication, and/or indicating other characteristics and features of the connector and/or the device or system to which the connector is inserted.

FIG. 4 illustrates a fourth implementation of the tactile orientation devices disclosed in the current document. In this implementation, the tactile orientation device is a depression 402 in the top surface 404 of the rectangular connector body 406. As with the protruding tactile orientation devices shown in FIGS. 1-3, tactile orientation device 402 breaks the otherwise 2-fold or 4-fold symmetry of the rectangular connector body along the length wise, central axis so that a user can determine the orientations of the rectangular connector body and the USB connector 408 by feel, alone.

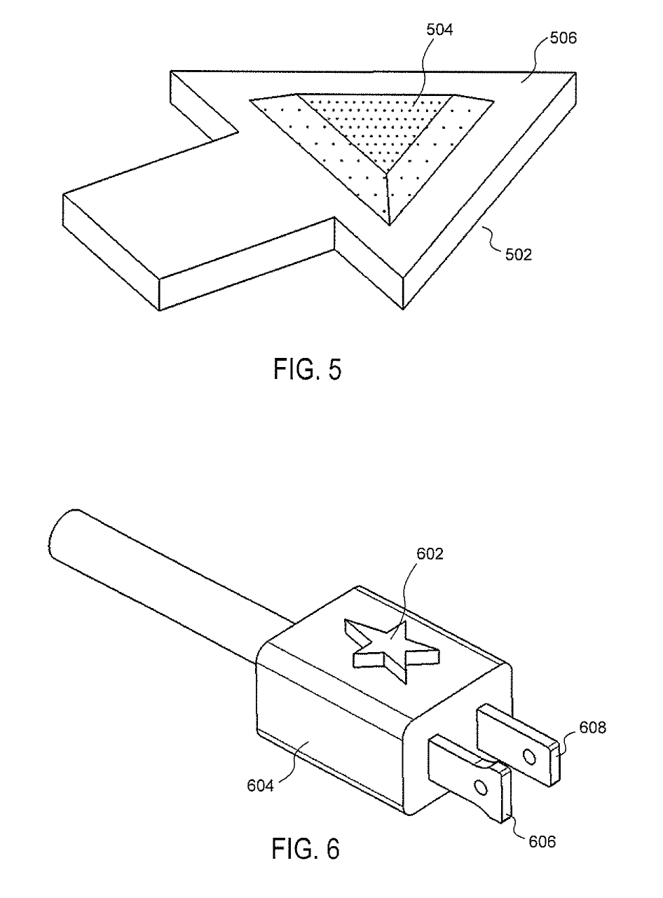

FIG. 5 illustrates a fifth implementation of the tactile orientation devices disclosed in the current document. The tactile orientation device 502 shown in FIG. 5 has an arrow-like shape that conveys directional information to a user. A raised triangular feature 504 on the top surface 506 of the tactile orientation device 502 can facilitate tactile determination of the directional orientation of the tactile orientation device 502 and may provide additional information to a user holding or touching the tactile orientation device and the object to which it is mounted or within which it is incorporated. In FIG. 5, the surface of the raised triangular feature is stippled to indicate that the surface of the raised triangular feature may have additional texture, small-sized features, or other characteristics and properties that provide additional information to a user as well as facilitating determination of the orientation of the tactile orientation device. For example, different surface textures, small-grain features, and other characteristics may indicate different types of objects to which the tactile orientation feature is mounted or within which the tactile orientation device is incorporated. As with previously described tactile orientation features, the raised feature may provide mechanical advantage for manipulating the object to which the tactile orientation device is mounted or within which the tactile orientation device is incorporated. The tactile orientation feature may be mounted to an underlying object using adhesive, a pin or post interconnect, a ball-and-socket press fit, or by magnetic attraction, in which case one or more magnets are incorporated within either or both of the tactile orientation device and the object to which the tactile orientation device is mounted or within which the tactile orientation device is incorporated.

FIG. 6 illustrates a sixth implementation of the tactile orientation devices disclosed in the current document. In FIG. 6, the tactile orientation device 602 is a star-shaped and is mounted to a power-cable plug 604. The plug has a first, wider connector 606 and a second narrower connector 608, and must be properly oriented for insertion into an outlet with two differently sized apertures for the connectors. When a user feels the star-shaped tactile orientation device 602 at the top of the plug, the user knows that the plug is properly oriented for insertion into an outlet.

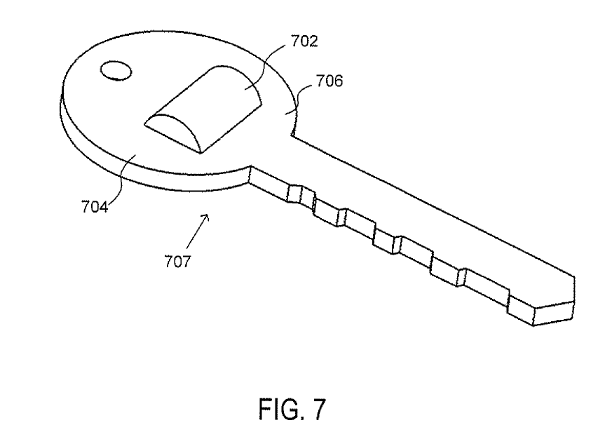

FIG. 7 illustrates a seventh implementation of the tactile orientation devices disclosed in the current document. In FIG. 7, a tactile orientation device 702 with a cylindrical surface is mounted to, or incorporated on, the surface of a key 704. This is tactile orientation device allows a user to differentiate, by feel, the top side of the key 706 from the reverse bottom side 707. When a user feels the tactile orientation device on the right-hand side of the key, when the key handle is vertically oriented, the user knows that the teeth of the key are pointed downward. This allows a user to correctly orient the key prior to insertion into a key slot.

In addition to facilitating orientation of an engagement future of an object, the currently disclosed tactile orientation devices may additionally provide mechanical stability and strain relief to a cable/plug/connector assembly. This mechanical stability and strain relief may decrease or eliminate various types of wear and damage otherwise suffered by the cable/plug/connector assembly. The above-discuss tactile orientation devices each includes a single piece or feature. In alternative implementations, the tactile orientation device may include multiple features arranged in a pattern on one or more surfaces of an object. As mentioned briefly, above, tactile orientation devices with different textures or other surface characteristics and/or with different easily distinguished shapes and sizes, can be used to allow users to differentiate, by feel, different types of devices, such as differentiating micro-USB B connectors from USB Mini-b connectors or between USB A type connectors and HDMI connectors. As also mentioned above, certain types of mechanical attachments allow tactile orientation devices to be reversibly attached to an object which, in turn, allows different types of tactile orientation devices to be mounted to various objects at different times. Tactile orientation devices may be rigid, semi-rigid, flexible, or pliable, depending on the type of object to which there are attached are within which they are incorporated as well as the types of use for the object and the types of manipulation commonly applied to the object. As discussed above, various types of visual cues, including lighting, labeling, numbering, coloring, and altering the surface reflectivity may be used to impart in this additional information to users.

Although the present invention has been described in terms of particular embodiments, it is not intended that the invention be limited to these embodiments. Modifications within the spirit of the invention will be apparent to those skilled in the art. For example, in one implementation, the tactile orientation devices on connector at each end of a cable may be complementary Velcro™ strips that have an additional use of joining the ends of the rolled-up cable together when the cable is not being used. A similar implementation may use magnets. Such dual-use tactile orientation devices may also be used to securely store the cable when not in use. Many additional implementations are possible by varying the shapes, sizes, locations, textures, colors, reflectivities, and other characteristics of the tactile orientation devices and the materials from which they are fabricated.

It is appreciated that the previous description of the embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An object on or within which a tactile orientation device is incorporated to provide for tactile orientability, the object comprising:
an engagement feature that is inserted into one of a complementary slot, port, and connector,
a grasping surface or grasping component from which the engagement feature extends, the grasping surface or grasping component having a greater symmetry with respect to rotation about an axis parallel to a direction of insertion of the enjoyment feature into the complementary slot, port, or connector than that of the engagement feature; and
the tactile orientation device, mounted to, affixed to, or incorporated within the grasping surface to reduce the symmetry of the grasping surface or grasping component with respect to rotation about the axis parallel to the direction of insertion of the enjoyment feature into the complementary slot, port, or connector.

2. The object on or within which a tactile orientation device is incorporated to provide for tactile orientability of claim 1 wherein the object is data-transmission and/or power-transmission cable.

3. The object on or within which a tactile orientation device is incorporated to provide for tactile orientability of claim 2 wherein the grasping component is a connector body that connects a cable to an electrical-connector engagement feature.

4. The object on or within which a tactile orientation device is incorporated to provide for tactile orientability of claim 1 wherein the object is a key.

5. The object on or within which a tactile orientation device is incorporated to provide for tactile orientability of claim 4 wherein the grasping component is a key handle and the engagement feature is a key shaft.

6. The object on or within which a tactile orientation device is incorporated to provide for tactile orientability of claim 1 wherein the tactile orientation device permanently affixed to the object.

7. The object on or within which a tactile orientation device is incorporated to provide for tactile orientability of claim 1 wherein the tactile orientation device is removably mounted to the object by one of:
a pin or post interconnect;
a ball-and-socket press fit; and
magnetic attraction.

8. The object on or within which a tactile orientation device is incorporated to provide for tactile orientability of claim wherein the tactile orientation device as a surface texture different from that of the grasping surface or grasping component and different from one or more related types of tactile orientation devices, the texture indicating a type of connector or type of complementary slot, port, or connector into which the engagement feature is inserted.

9. The object on or within which a tactile orientation device is incorporated to provide for tactile orientability of claim wherein the tactile orientation device includes a light source.

10. The object on or within which a tactile orientation device is incorporated to provide for tactile orientability of claim wherein the tactile orientation device includes one or more additional visual indications selected from:
labels;
numerals;
markings;
a color; and
a reflectivity characteristic.

11. The object on or within which a tactile orientation device is incorporated to provide for tactile orientability of claim 1 wherein the tactile orientation device protrudes outward from the grasping surface or from the surface of the grasping component.

12. The object on or within which a tactile orientation device is incorporated to provide for tactile orientability of claim 1 wherein the tactile orientation device is a depression within the grasping surface or from the surface of the grasping component.

13. The object on or within which a tactile orientation device is incorporated to provide for tactile orientability of claim 1 wherein the tactile orientation device additionally provides a mechanical advantage for inserting the engagement feature into, or removing the engagement feature from, the complementary slot, port, or connector.

14. The object on or within which a tactile orientation device is incorporated to provide for tactile orientability of claim wherein the tactile orientation includes multiple, separate features arrange on the grasping surface or on the surface of the grasping component.

15. A method that provides for tactile orientability of an object, the method comprising:
mounting a tactile orientation device to, or incorporating the tactile orientation device within an object that includes
an engagement feature that is inserted into one of a complementary slot, port, and connector, and
a grasping surface or grasping component from which the engagement feature extends, the grasping surface or grasping component having a greater symmetry with respect to rotation about an axis parallel to a direction of insertion of the enjoyment feature into the complementary slot, port, or connector than that of the engagement feature;
wherein the tactile orientation device reduces the symmetry of the grasping surface or grasping component with respect to rotation about the axis parallel to the direction of insertion of the enjoyment feature into the complementary slot, port, or connector.

16. The method of claim 15 wherein the object is data-transmission and/or power-transmission cable.

17. The method of claim 16 wherein the grasping component is a connector body that connects a cable to an electrical-connector engagement feature.

18. The method of claim 15 wherein the object is a key.

19. The method of claim 15 wherein the grasping component is a key handle and the engagement feature is a key shaft.
